(19) United States
(12) Patent Application Publication
(10) Pub. No.: US 2017/0061471 A1
(43) Pub. Date: Mar. 2, 2017

(54) CACHE AND UNIFORM RESOURCE LOCATOR BASED EVENT TRACKING

(71) Applicant: Linkedln Corporation, Mountain View, CA (US)

(72) Inventor: Xiang Yu, Sunnyvale, CA (US)

(21) Appl. No.: 14/839,618

(22) Filed: Aug. 28, 2015

(51) Int. Cl. G06Q 30/02; H04L 29/08

(52) U.S. Cl. CPC G06Q 30/0246; H04L 67/22; H04L 67/2842; G06Q 30/0275; G06Q 30/0277

(57) ABSTRACT

Generally discussed herein are methods, systems, and apparatuses for event tracking using Uniform Resource Locators (URLs) and one or more caches. A method can include determining whether an entry in any of the one or more URL caches includes a same universally unique identifier (UUID) as a received winning event URL or a received advertising event URL, merging data from the received winning event URL or the received advertising event URL with data in the entry that is not present in the entry, creating a new entry in a cache of the one or more URL caches that includes the UUID, or updating a persistent storage with the data from the entry, and providing a bill for serving advertisements or analytics information, the bill or analytics information determined using data from the entry in the persistent storage.

### TECHNICAL FIELD

Examples generally relate to systems, apparatuses, and methods for tracking event data using a cache and a Uniform Resource Locator (URL). More specifically, one or more embodiments relate to tracking advertisement click event and impression event data using a URL and a cache, such as to help ensure that the length of the URL does not exceed a size limit of a web browser and or an advertisement exchange server.

### BACKGROUND

A cache store is different from other memories in that the data stored on a cache is stored temporarily and is not persistent. The data in a cache has a time to live (TTL) associated with it, such that data is removed from the cache in response to expiration of a corresponding TTL. The data may be removed from the cache prior to the expiration of the TTL if certain specified conditions are met. One example of a cache data store is the open source Couchbase Server deployed as a distributed cache store. A memory or other device that stores data that does not have such a TTL or otherwise expires is referred to herein as a persistent storage.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed herein.

FIG. 1 illustrates, by way of example, an embodiment of a system for advertising event tracking using URLs and a cache.

FIG. 2 illustrates, by way of example, an embodiment of another system for advertising event tracking using URLs and a cache.

FIG. 3 illustrates, by way of example, an embodiment of another system for event tracking using URLs and a cache.

FIG. 4 illustrates, by way of example, an embodiment of a method for cache-based URL event handling.

FIG. 5 illustrates, by way of example, an embodiment of another method for cache-based URL event handling.

FIG. 6 illustrates, by way of example, a flow diagram of an embodiment of a method for cache based impression event URL and click event URL tracking.

FIG. 7 illustrates, by way of example, a flow diagram of an embodiment of a method for cache based wining event URL tracking.

FIG. 8 illustrates, by way of example, a block diagram of an embodiment of a computer network environment in which the systems and methods discussed herein can be deployed and/or performed.

FIG. 9 illustrates, by way of example, a block diagram of an embodiment of a software architecture, which may be used in conjunction with various hardware architectures herein described.

FIG. 10 illustrates, by way of example, a block diagram of an embodiment of a machine able to read instructions from a machine-readable medium (e.g., a machine-readable storage medium) and perform any one or more of the methodologies discussed herein.

### DETAILED DESCRIPTION

Discussed generally herein are systems, devices, and methods for tracking event data using one or more URLs and one or more cache stores. The event data can include a click event, impression event, or a winning event. The event data can be embodied in a URL that includes details regarding the event (e.g., details that are encrypted). If more details surrounding the event data are provided in the URL, the URL can become prohibitively long, such as to make the length of the URL greater than a maximum allowable length. If the URL exceeds the maximum allowable length the URL is truncated to make the URL within the maximum allowable length. Truncating the URL can remove data that is needed to charge an advertiser client for the advertising event (e.g., a click event or an impression event) with which the URL is associated. Thus, such a truncation can lead to lost revenue.

An advertising event URL is either a click event URL or an impression event URL. A click event URL includes details regarding a user selecting an advertisement for viewing. An impression event URL includes details regarding an advertisement appearing on a display that the user is (presumably) viewing. A winning event URL includes details regarding a winning bid price of an advertisement opportunity, such as through a Real Time Bidding (RTB) server.

To help avoid lost revenue due to truncation, the URLs can be kept shorter than the minimum of the maximum allowable URL size limit of an RTB exchange server, a web browser of a user to be presented with the data corresponding to the URL, and/or any other device in the URL pipeline. The pipeline includes the modules and other devices from the ads serving to the ads tracking and other data storage. Generally, the web browser of the user has the smallest maximum allowable URL length of the devices in the URL pipeline. In such cases, the maximum allowable URL length is the maximum allowable URL length of the web browser. However, this maximum allowable URL length may not be sufficient to allow all of the data of the event being tracked to be appended into the same URL.

To help avoid the URL truncation, the URL data can be limited to include data that is guaranteed to not exceed the maximum allowable size limit. In one or more embodiments, the URL can be split into multiple URLs that are each associated with an identifier that uniquely identifies the advertising event (a universally unique identifier (UUID)). A first URL of the multiple URLs can be stored in a cache. When a second URL of the multiple URLs is received, it can be determined if a URL associated with the same UUID is already in the cache. If there is a URL associated with the same UUID in the cache, then the URLs can be joined in the cache. The cache does not have a prohibitively short maximum URL length so there is generally no issue regarding URL length in the cache. Such an embodiment allows segregation of URL data, such as by providing a URL that includes data regarding the service of the advertisement, a URL for tracking of the advertisement, and a URL for details regarding winning a bid using an RTB exchange. Such a configuration helps the URL length stay below the maximum allowable URL length and helps guarantee that no revenue is lost due to URL truncation.

Also, one or more embodiments discussed herein can facilitate a data join that merges data stored in a cache with data in a URL received after a tracking event or winning event has occurred. The joined data can be associated with a common UUID. Such embodiments provide an easy way to aggregate data and persist the data to a more permanent storage than a cache.

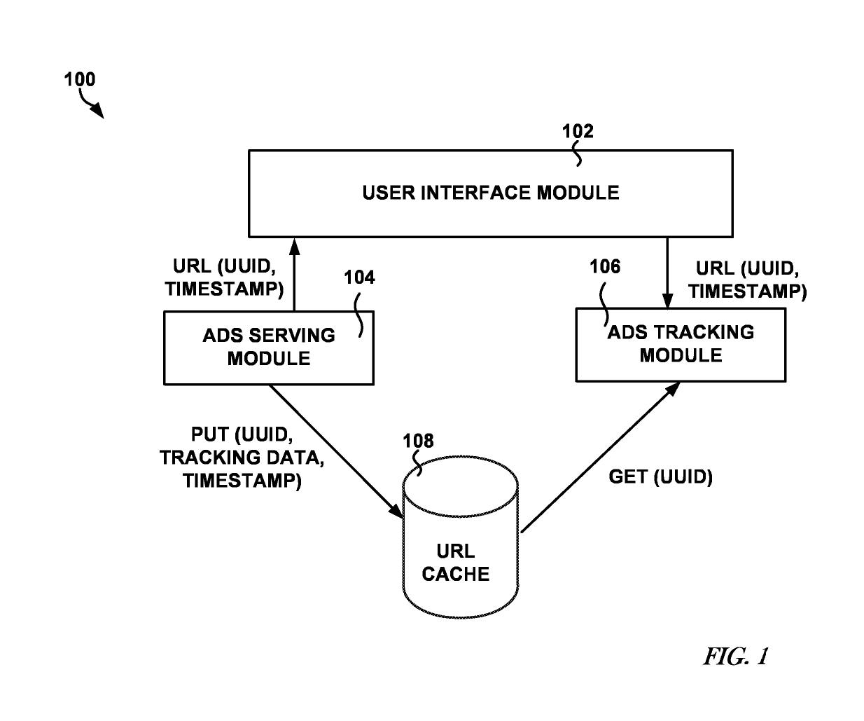

FIG. 1 illustrates, by way of example, an embodiment of a system 100 for event tracking using URLs and a cache. The system 100 as illustrated includes a user interface (UI) module 102, an advertisement serving module 104, an advertisement tracking module 106, and a cache 108.

The UI module 102 provides signals to a display that cause the display to provide a user with a view of a webpage (e.g., a social networking site, for example the social networking site accessible at www.linkedin.com, operated by LinkedIn Corporation of Mountain View, Calif., United States). The UI module 102 receives signals from the display indicative of user interactions with the webpage. The user interactions can include scrolling through the webpage and/or selecting an object displayed on the webpage.

The webpage can include advertisements displayed thereon. The advertisements can each be related to an advertisement campaign. The advertisement campaign includes an advertiser paying to have their advertisements presented to and/or interacted with by a user. The advertiser can specify that they will pay to have the advertisement presented to a specified number of users (i.e. to have a certain number of impressions) or can specify that they will pay to have a specified number of user interactions with the advertisements (i.e. to have a certain number of “clicks”). The main difference between the impression event and the click event is that in the impression event the advertiser does not care if the user actively interacts with the advertisement and the user can merely scroll past the advertisement to satisfy the impression event criteria. In the click event the advertiser is only concerned with the number of active user interactions with the advertisement, such as the number of times a user selects the advertisement, including clicking, touching, or otherwise selecting the advertisement.

The UI module 102 provides the ads tracking module 106 with advertising event URLs that include data detailing a user being shown an advertisement (i.e. an impression event) or a user clicking on or otherwise selecting an advertisement (i.e. a click event). The impression event and the click event include a UUID that identifies the advertising opportunity.

The advertisements to be presented using the UI module 102 are provided by the ads serving module 104. The ads serving module 104 provides the UI module 102 with the advertisement data or a URL that indicates a location at which the advertisement can be retrieved. The URL of the advertisement provided by the ads serving module 104 includes a UUID and an optional time stamp. The UUID is a series of bits that uniquely identifies the advertisement serving event and the associated advertisement. The timestamp indicates a time at which the ad was provided to the UI module 102. The ads serving module 104 records the ads serving event in the cache 108, such as by performing a put operation that includes the UUID of the ad serving event and event tracking data. The event tracking data can include an identification of a device that is being used to access the webpage, a location of the advertisement on the webpage, a timestamp indicating a time at which the advertisement was on the display, data about the entity viewing the ad (e.g., a member id), advertiser/advertisement data (e.g., advertiser id, campaign id, creative id, campaign charge type), cost data (e.g., bid price, exchange rate, currency), and/or ad request information (e.g., internet protocol address, browser data, etc.).

The ads serving module 104 can provide a TTL in the entry in which the URL is recorded in the cache 108. The TTL defines a time at which the entry in the cache is to be removed from the cache 108, such as by defining an amount of time the URL is to remain in the cache 108, such that when the amount of time has lapsed the URL is removed from the cache 108, or identifying a time at which the entry is to be removed from the cache 108. The TTL is user-configurable. The TTL can be set so as to help ensure that the number of URLs stored in the cache 108 does not fill up the cache, yet the URL remains long enough so that a determination as to an amount an advertiser can be charged for the advertising event can be made for a majority of the ads serving URLs in the cache 108.

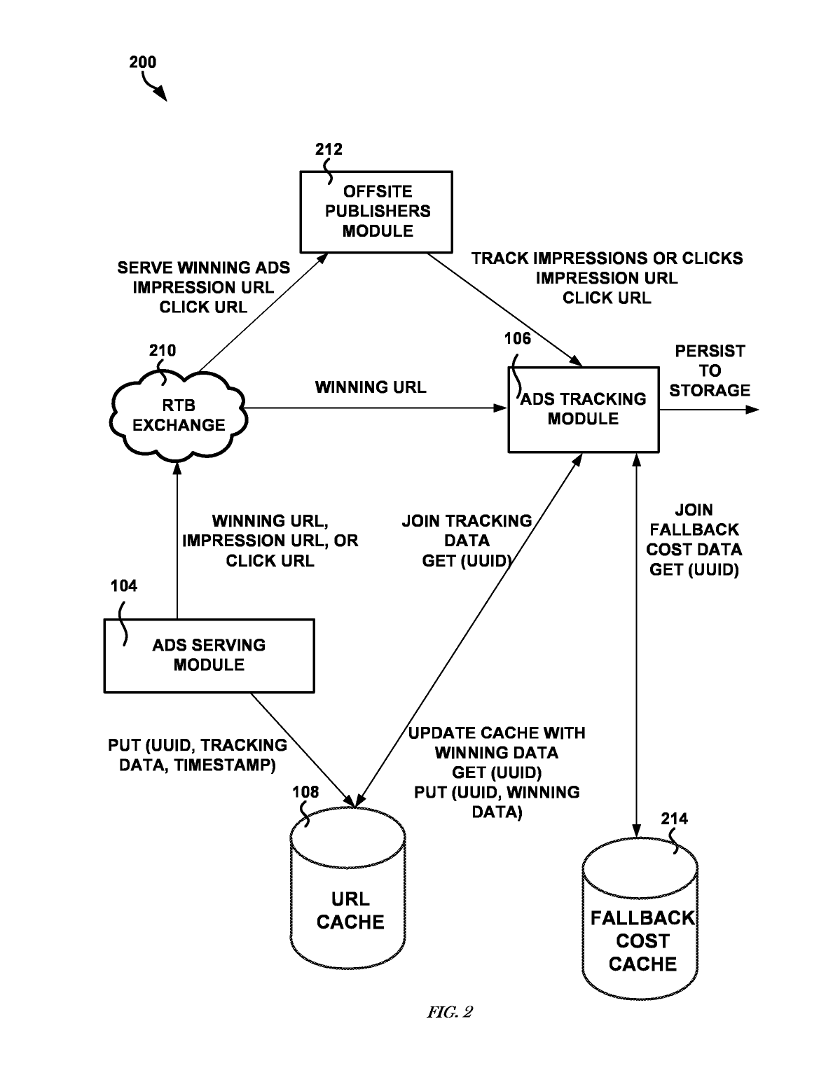

The cache 108 generally includes a single TTL that defines the life of data in the cache 108. The TTL can be updated to a different value based on the type of tracking event or winning event with which he data is associated. For example, initial tracking data from a tracking event URL can include a first TTL, such as two hours, which can be updated to a second TTL, such as twenty-four hours, in response to receiving a winning event data from the RTB exchange (see FIG. 2, for example). The write to the cache 108 from the ads serving module 104 can include a timestamp that indicates a time at which the ads serving URL was provided to the UI module 102 and/or to the cache 108.

The ad tracking module 106 receives impression event URLs and click event URLs from the UI module 102. The URL received from the UI module 102 includes the UUID of the event opportunity and a timestamp indicating a time at which the event opportunity occurred. The ads tracking module 106 determines if the cache 108 includes an entry associated with the same UUID as the UUID in the URL. If the cache 108 includes such an entry, the ads tracking module 106 joins the data in the URL from the UI module 102 with the data in the entry in the cache 108 that is associated with the UUID. The join includes constructing the full received tracking data by appending or adding data that is present in the ads tracking URL from the UI module 102 and not present in the entry of the cache 108 associated with the UUID with the entry, and sending the full received tracking data to a separate persistent storage, such as for analytics or billing purposes. If the cache 108 does not include such an entry, the ads tracking module 106 can write a new entry in the cache 108, such as by performing a put operation with the new UUID. If the cache does not include such an entry the tracking event could have arrived after a valid charging window and the cache TTL for the entry has since expired. In such a case, the data from the received URL may be sent to the persistent storage without first creating an entry in the cache or storing any data from the received URL in the cache.

The cache 108 can be a centralized cache or a distributed cache. If the cache 108 is a distributed cache, the ads tracking module 106 determines if an entry in any of the distributed caches 108 is associated with the UUID. If the cache 108 is a centralized cache, the ads tracking module 106 determines if an entry in the centralized cache is associated with the UUID. The cache 108 can be indexed in accord with an account ID and/or a UUID. The account ID uniquely identifies the advertiser and/or the advertisement campaign with which the advertising event URL or winning event URL is associated with. The UUID identifies a single impression or click event that might be billed to the advertiser.

There is no guarantee that a winning event URL associated with the same UUID as the advertising event URL will be received within the time window defined by the TTL. To help ensure that revenue is received for each billable click or impression event, a fallback cost can be used in place of an actual cost. More details regarding the fallback cost are discussed with regard to at least FIGS. 2, 3, 6, and 7.

There is no guarantee that a served ad will create a click or an impression event. Consider an example in which a user is viewing the webpage using their mobile device and the ad is situated on the webpage such that the user needs to scroll down to view the ad. If the user does not scroll down so as to make the ad appear on the screen of their mobile device, then no impression event has been attained, and no billing should occur even though the ad was served.

The system 100 provides a flexible platform to track URLs, while maintaining some controls on the number of URLs that are stored in the cache 108. The system 100 is user-configurable so as to allow for flexibility in the size of the cache 108, the TTL of entries in the cache 108, and track the data required for billing and analytics so that minimal to no data is lost due to URL truncation.

FIG. 2 illustrates, by way of example, an embodiment of a system 200 for event tracking using URLs and a cache. The system 200 as illustrated includes the ads serving module 104, the ads tracking module 106, and the URL cache 108 as discussed with regard to FIG. 1. The system 200 as illustrated further includes an RTB exchange 210, an offsite publishers module 212, and a fallback cost cache 214. The UI module 102 of FIG. 1 is not shown in the system 200 so as to not obfuscate the view of the items of the system 200. The UI module 102 can be communicatively coupled to the ads serving module 104 and/or the ads tracking module 106 as shown in FIG. 1.

The ads serving module 104 as illustrated is communicatively coupled between the RTB exchange 210 and the cache 108. The ads serving module 104 writes advertising event URLs to the URL cache 108, such by performing a put operation. The ads serving module 104 can provide the RTB exchange 210 with a winning event URL, an impression event URL, or a click event URL. Note that an advertising event URL corresponds to either an impression event URL or a click event URL. The winning event URL can include the UUID of the event opportunity, a timestamp, and/or a bid price that will be paid to the entity that serves the ad and creates an impression or click event. The impression event URL can include the UUID of the event opportunity and/or a timestamp. The click event URL can include the UUID, an indication of the publication to be selected (e.g., clicked), and/or a timestamp. The winning event URL and the impression event URL can include a URL that points to a location at which the ad (e.g., creative, publication, or other advertising content) is stored.

The RTB exchange 210 is a server and/or other hardware and software that provides a software-based auction for advertising space on a webpage. A webpage operator determines that they have space to fill in their webpage and allow advertisers to bid for the chance to serve an ad in that space. An advertiser (e.g., the advertising entity itself or a proxy for the advertiser, such as an operator of a social networking site), can determine if the ad serving chance is associated with a user of a webpage, such as a social networking site. The advertiser can have access to the profile of the user, such as to help in targeting ads to proper users and increase the chances of the user interacting with the ad. The advertiser submits a bid indicating how much money will be paid for the opportunity to serve the ad and the opportunity to create an impression or a click event. In one or more embodiments, the advertiser only bids on opportunities to serve ads to users of a specific webpage, such as the social networking site.

The RTB exchange 210 serves winning ads (ads from advertisers that bid the highest amount for the opportunity to create an impression event or click event through the auction hosted by the RTB exchange 210) to the offsite publishers module 212 in the form of an impression event URL or a click event URL. The RTB exchange 210 provides the ads tracking module 106 with a winning event URL, such as if the winning URL is associated with the entity operating the ads tracking module 106.

The offsite publishers module 212 includes the hardware and software components required to serve an ad to a user. The ads served to the user through the offsite publishers module 212 are ads that won the auction through the RTB exchange 210. The ads serving module 104 can perform the same function as the offsite publishers module 212, with the ads serving module 104 serving ads to the user locally (i.e. on a webpage hosted by the entity operating the ads serving module 104 and to the UI module 102). That is, consider that LinkedIn hosts the ads serving module 104, the ads serving module 104 can serve ads to LinkedIn webpages through the UI module 102, while the offsite publishers module 212 serves ads that LinkedIn is getting paid to serve but to a non-LinkedIn website.

Similar to the ads serving module 104, the offsite publishers module 212 tracks whether the ad that has been served has created an impression event or a click event. In response to determining that an impression event has occurred (e.g., a user has manipulated their view of the webpage such that the ad was displayed to the user) the offsite publishers module 212 provides an impression URL to the ads tracking module 106. In response to determining that a click event has occurred (e.g., a user has selected an ad that was displayed after winning the opportunity through the RTB exchange 210) the offsite publishers module 212 provides a click URL to the ads tracking module 106.

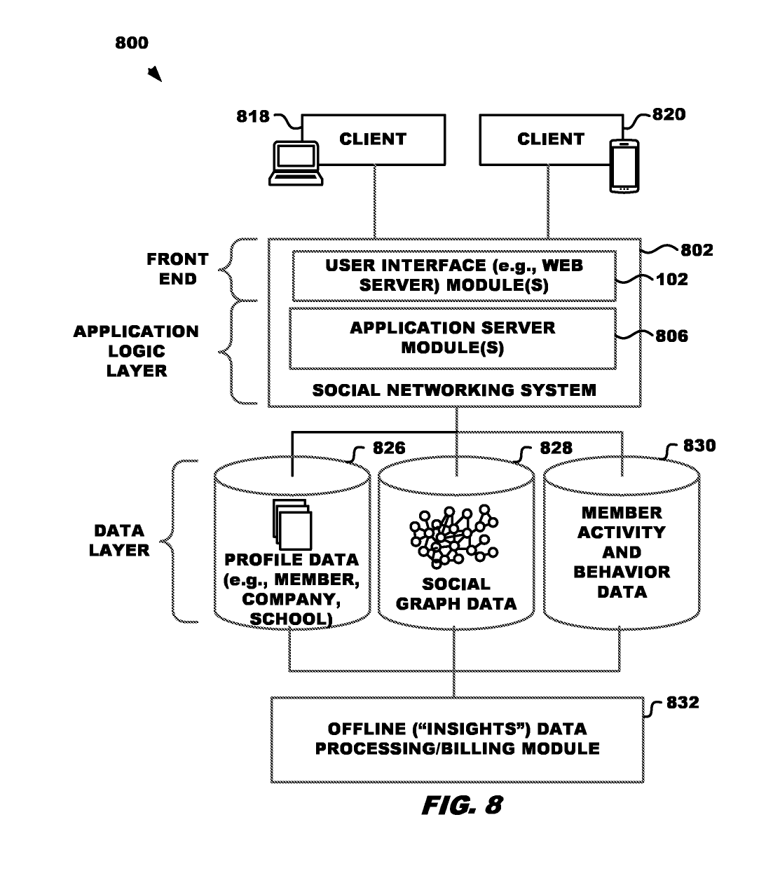

The ads tracking module 106 determines whether an impression URL or a click URL is associated with a revenue generating event. In one or more embodiments, if the URL is associated with a revenue generating event, the ads tracking module 106 determines if any more or all of the information (e.g., advertiser, ad, bid price, charge price, etc.) regarding the event has been received. The ads tracking module 106 can perform this by determining what information is in the received URL and what information is in the URL cache 108, such as by performing a get operation based on the UUID. If the ads tracking module 106 determines that all of the information required to bill the advertiser is present, then the ads tracking module 106 provides the data to persistent storage, such as a non-volatile memory, see FIG. 8. If the ads tracking module 106 determines (1) that all of the information required to bill the advertiser but the bid price of the winning bid, an advertiser cost, or other cost data required to determine how much to charge the advertiser and (2) that the TTL of the data in the cache 108 is about to elapse, or (3) that no more information regarding the advertisement opportunity will be received from any of the RTB exchange 210 or the offsite publishers module 212, then the ads tracking module 106 looks up how much to charge the advertiser in the fallback cost cache 214. The ads tracking module 106 can add the fallback cost data received from the fallback cost cache 214 to the associated URL and either write the URL to persistent storage or the cache 108. Writing the fallback cost data to the cache can include performing a join operation on an entry in the cache 108 associated with the UUID of the tracking event and the data from the RTB exchange 210, the offsite publishers module 212, or the fallback cost cache 214 that is associated with the same UUID.

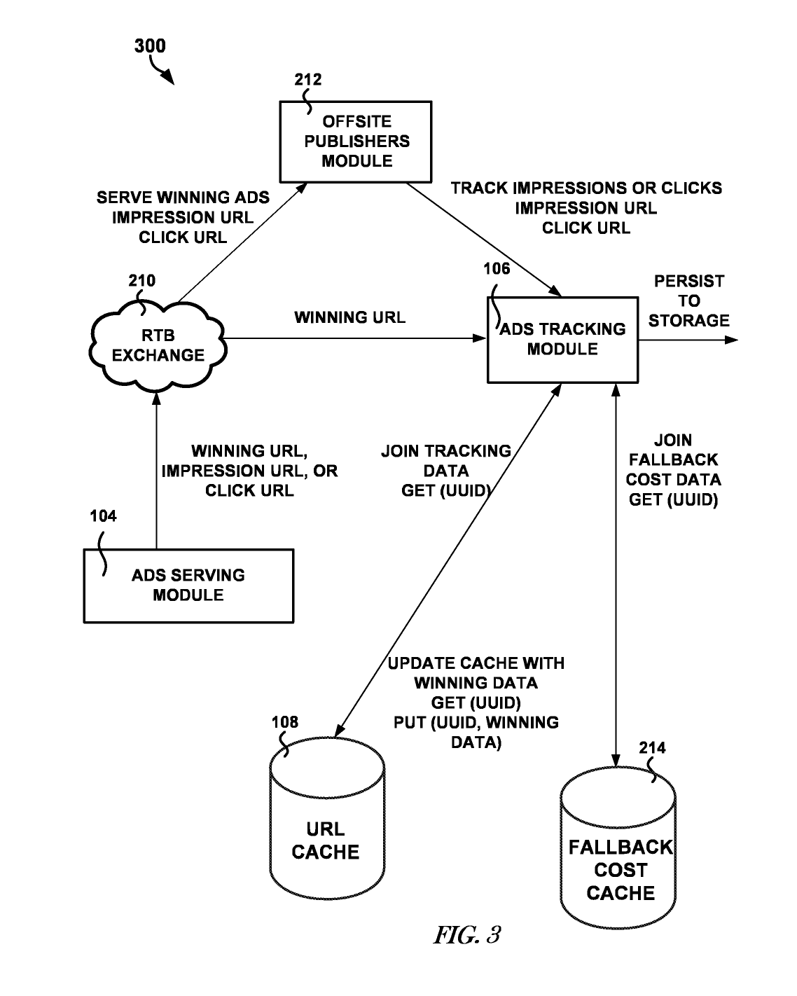

FIG. 3 illustrates, by way of example, an embodiment of another system 300 for event tracking using URLs and a cache. The system 300 as illustrated includes the same items as the system 200. The difference between the system 200 and 300 is the interaction between the ads serving module 104 and the cache 108. In the embodiment of FIG. 3, the ads serving module 104 does not store the URL in the cache 108 every time a bid is placed in the RTB exchange 210, whereas in the embodiment of FIG. 2, the ads serving module 104 stores the URL in the cache 108 every time a bid is placed to the RTB exchange 210.

Using the system 200, URLs are more likely to be of shorter length than the URLs of the system 300. This is because the URLs served from the ads serving module 104 need to retain all of the information that is added to them from the ads serving module 104, the RTB exchange 210, the offsite publishers module 212, and the ads tracking module through to the time they are stored in the cache 108 or persistent storage, so as to help ensure that no data is lost in the system 300. Whereas, in the system 200 the impression URL or the click URL served to the RTB exchange 210 need not include information stored in the cache 108 that is not necessary for the RTB exchange 210. However, the cache 108 of the system 200 will likely include more entries than the cache 108 of the system 300 because the ads serving module 104 writes to the cache 108 every time an ad is served to the UI module 102 or the RTB exchange 210, while the ads serving module 104 of the system 300 does not write to the cache 108 every time an ad is served. In the system 300, the cache 108 is only written to after an ad wins the auction in the RTB exchange 210 and an impression or click event is more likely to occur. Since not all ad URLs submitted to the RTB exchange 210 and not all ads that are served create an impression event or click event, the number of entries in the cache 108 of the system 300 should be less (e.g., much less, sometimes only ten percent of the number of entries in the cache 200) than that in the cache 108 of the system 200. To handle the extra URL entries, the TTL of the entries in the cache 108 can be specified so that the cache 108 does not become prematurely full.

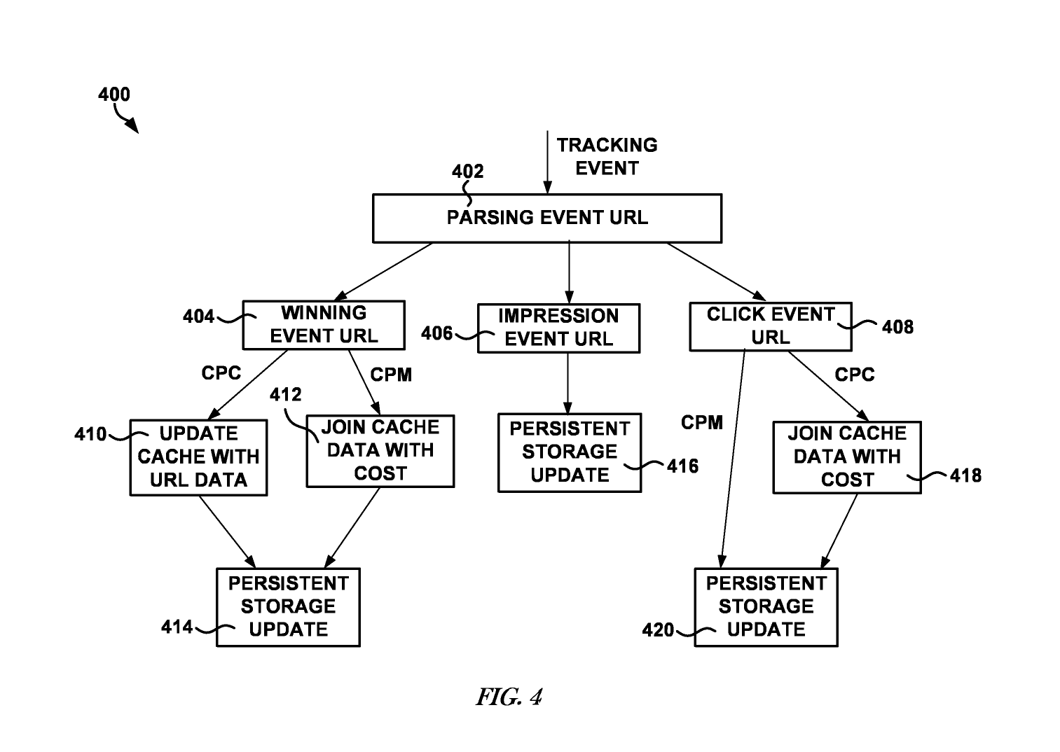

FIG. 4 illustrates, by way of example, an embodiment of a method 400 for cache-based URL event handling. In one or more embodiments, the method 400 is implemented by the ads tracking module 106, the cache 108, and the persistent storage (see the data layer of FIG. 8 for examples of persistent storage), and the fallback cost cache 214. The method 400 includes operations to be performed in a method in which a winning event URL is treated as a tracked impression event that has occurred. At operation 402 a tracking event URL is parsed according to event type. The tracking event URL is parsed into either a winning event URL at operation 404, an impression event URL at operation 406, or a click event URL at operation 408. One or more fields or bits of the URL can indicate the URL event tracking event type of the URL. If the event URL is a winning event URL and the URL corresponds to a cost per click (CPC) event, the URL cache is updated to include an entry corresponding to the cost per click event at operation 410. If the event URL is a winning event URL and the URL corresponds to a cost per impression (CPM) event, a join operation is performed to include the winning bid information from the URL with data in an entry in the cache associated with a same UUID as a UUID of the winning event URL at operation 412. The entry in the URL cache is written to persistent storage at operation 414, such as in response to performing the join operation, after the TTL expires, the cache includes a specified number of entries, or other trigger event occurs.

If the event URL is an impression event URL, the impression event URL is sent directly to persistent storage at operation 416, such as without storing the URL in the URL cache prior to writing the URL data to persistent storage. If the event URL is a click event URL and the ad campaign associated with the ad is a cost per impression campaign, the click event URL data is written directly to persistent storage at operation 420, such as without storing the URL in the cache prior to writing the URL data to persistent storage. If the event URL is a click event URL and the ad campaign associated with the ad is a cost per click campaign, the click event URL data is joined with data from the cache associated with the same UUID as the click event URL at operation 418. The entry in the cache is written to persistent storage at operation 420, such as in response to performing the join operation, the TTL expires, the cache includes a specified number of entries, or other trigger event occurs.

Note that the order in which a winning event URL and a tracking event URL associated with the same UUID alters how the cache is updated to include URL data. If a winning event URL is received first and the tracking event URL is received after the winning event URL, the cache can be updated to either include a new entry corresponding to the UUID of the winning event URL or the data can be joined with an entry in the cache associated with the same UUID. Then, when the tracking event URL is received, the data from the cache associated with the UUID is retrieved and either joined with the data from the tracking event URL in the cache or written to persistent storage with the data from the tracking event URL. Similarly, if a tracking event URL is received first and the winning event URL is received after the tracking event URL, the cache can be updated to either include a new entry corresponding to the UUID of the tracking event URL or the data from the tracking event URL can be joined with an entry in the cache associated with the same UUID. Then, when the winning event URL is received, the data from the cache associated with the UUID of the winning event URL is retrieved and either joined with the data from the winning event URL in the cache or written to persistent storage with the data from the winning event URL.

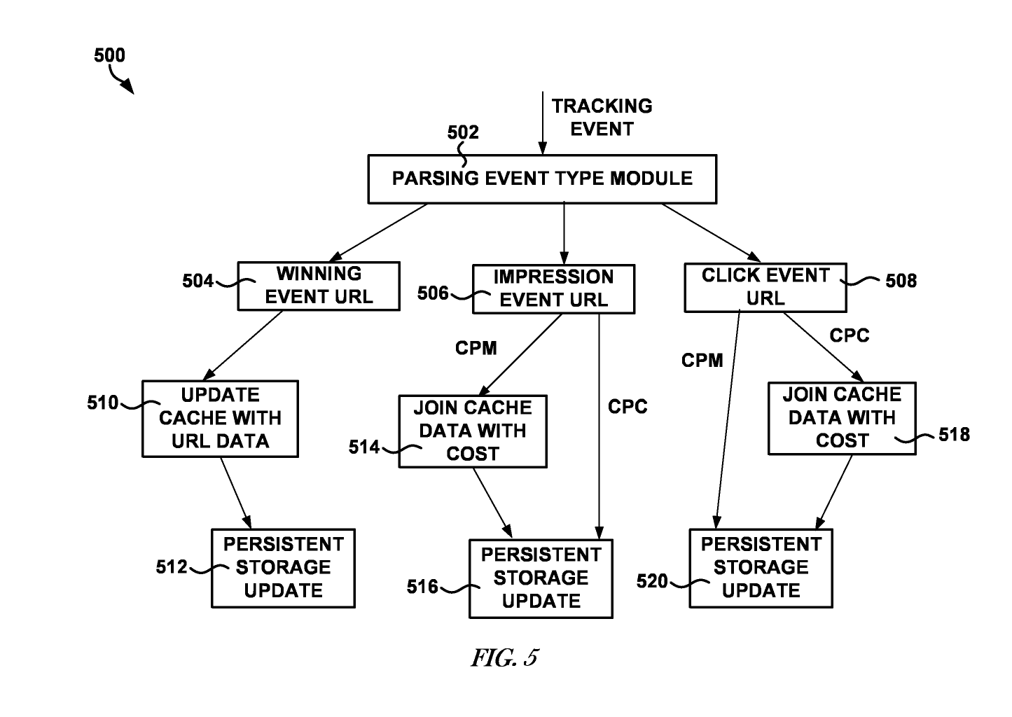

FIG. 5 illustrates, by way of example, an embodiment of another method 500 for cache-based URL event handling. In one or more embodiments, the method 500 is implemented by the ads tracking module 106, the cache 108, and the persistent storage (see the data layer of FIG. 8 for examples of persistent storage), and the fallback cost cache 214. The method 500 includes operations to be performed using impression pixel tracking as opposed to treating a winning event URL as an advertising event (e.g., an impression or a click event) as is shown in FIG. 4. At operation 502 a tracked event is parsed according to event type. The tracking event URL is parsed into either a winning event URL at operation 504, an impression event URL at operation 506, or a click event URL at operation 508. If the event URL is a winning event URL the cache is updated to include the information from the winning event URL. The data in the winning event URL can be written into a new entry in the cache if no entry in the cache is associated with a UUID that is the same as the UUID of the winning event URL at operation 510. Alternatively, the operation 510 can include joining the data in the winning event URL with an entry in the cache associated with a UUID that is the same as the UUID of the winning event URL. The entry in the cache is written to persistent storage at operation 512, such as after the TTL expires, the cache includes a specified number of entries, or other trigger event occurs.

If the event URL is an impression event URL and the ad campaign associated with the ad is a cost per click campaign, the impression event URL data is written directly to persistent storage at operation 516, such as without storing the URL in the cache prior to writing the URL data to persistent storage. If the event URL is an impression event URL and the ad campaign associated with the ad is a cost per impression campaign, the impression event URL data is joined with data from the cache associated with the same UUID as the impression event URL at operation 514. The entry in the cache is written to persistent storage at operation 516, such as after in response to joining the data stored in the cache (e.g., winning event and/or ads serving data) with the impression event data (e.g., data from the impression event URL.

If the event URL is a click event URL and the ad campaign associated with the ad is a cost per impression campaign, the click event data (e.g., tracking data retrieved from the cache according to UUID) is written directly to persistent storage at operation 520, such as without updating the cache (e.g., by storing URL data in the cache) prior to writing the URL data to persistent storage. If the event URL is a click event URL and the ad campaign associated with the ad is a cost per click campaign, the click event URL data is joined with data from the cache associated with the same UUID as the click event URL at operation 518. The entry in the cache is written to persistent storage at operation 520, such as in response to joining the data stored in the cache (e.g., winning event and/or ads serving data) with the click event data (e.g., data from the click event URL.

The method 400 does not include a write to the cache in the case of receiving an impression event URL, thus reducing the number of writes to the cache as compared to the method 500. However, the method 400 potentially records more impression events in the persistent storage than actually occur. This is because winning an opportunity to create an impression event or a click event does not guarantee that the impression event or click event will actually occur. Thus, an advertiser can be charged for more impressions than have actually occurred. Using the method 500, the persistent storage includes data that more accurately reflects the actual number of impression or click events that have occurred.

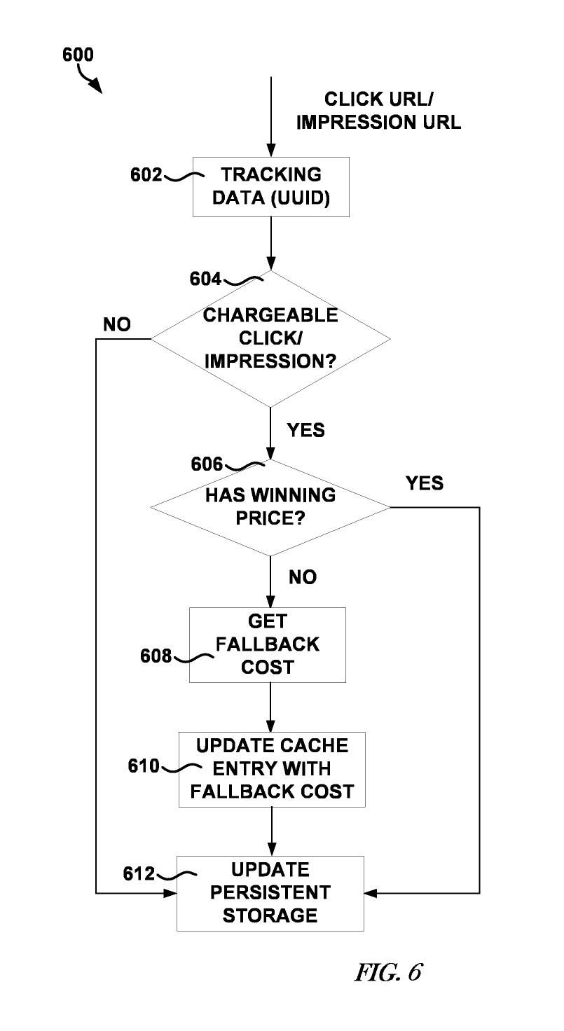

FIG. 6 illustrates, by way of example, a flow diagram of an embodiment of a method 600 for cache based impression event URL and click event URL tracking. In one or more embodiments, the method 600 is implemented by the ads tracking module 106, the cache 108, and the persistent storage (see the data layer of FIG. 8 for examples of persistent storage), and the fallback cost cache 214 The method 600 as illustrated includes receiving a click event URL or an impression event URL. Tracking data, based on the UUID of the impression event URL or click event URL, is retrieved from the cache at operation 602 if any such data is present in the URL cache. At operation 604 it is determined whether the URL corresponds to a chargeable click or impression event. The operation 604 can be performed by looking up the UUID in a table or database that includes data indicating whether the UUID corresponds to a chargeable event. If it is determined that the UUID corresponds to a chargeable event the method continues at operation 606. If it is determined that the UUID does not correspond to a chargeable event, the method 600 continues at operation 612 where a persistent storage is updated, such as for analytics purposes.

At operation 606 it is determined whether the URL includes a winning price, such as from an RTB exchange. If the winning price is included in the URL, all of the data needed to determine how much to charge the advertiser has been received, so there is no need to store the data in the cache. Data, such as a timestamp of the impression event or click event being served, a timestamp indicating a time the impression or click event occurred, a publication identifier, or other URL data in an entry in the cache associated with the same UUID as the UUID of the click URL or the impression URL may be retrieved from the cache prior to updating the persistent storage at operation 612. The update to the persistent storage can include updating data associated with an advertising campaign so as to generate revenue for the impression or click event and/or updating data to be used for advertising and other analytics.

If the winning price is not included in the URL (or an entry in the cache associated with the same UUID as the UUID of the click or impression event URL) a fallback cost to be charged to the advertiser for the click or impression event is retrieved at operation 608. At operation 610, the cache entry associated with the same UUID as the click or impression event URL is updated to include the retrieved fallback cost and/or other data in the click or impression event URL that is not currently in the entry in the cache. The data, such as can include the fallback cost or the winning cost, from the cache can be written to a persistent storage at operation 612.

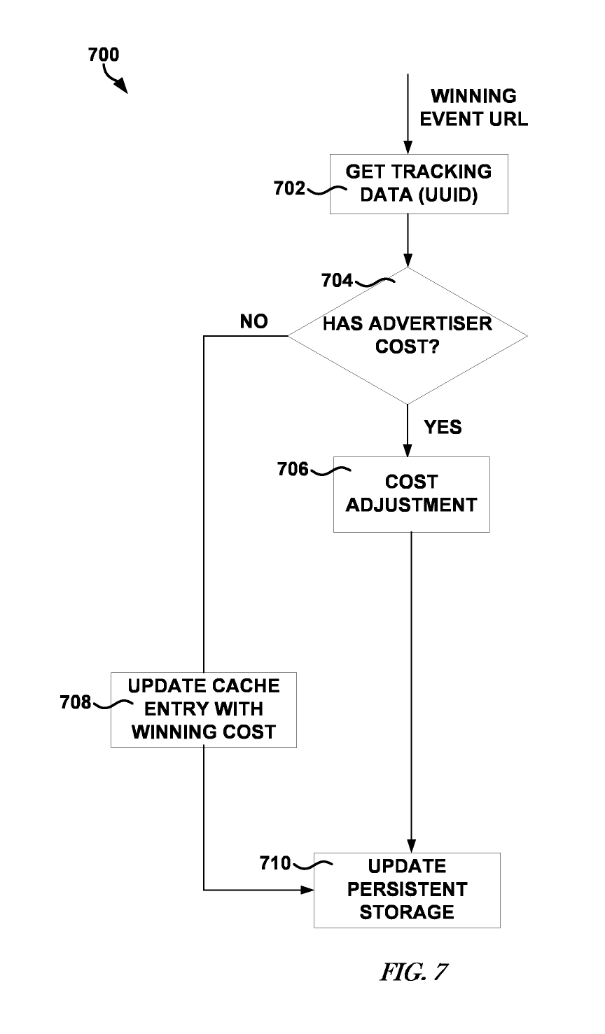

FIG. 7 illustrates, by way of example, a flow diagram of an embodiment of a method 700 for cache based wining event URL tracking. In one or more embodiments, the method 700 is implemented by the ads tracking module 106, the cache 108, and the persistent storage (see the data layer of FIG. 8 for examples of persistent storage), and the fallback cost cache 214 The method 700 as illustrated includes receiving a winning event URL. In response to receiving the winning event URL, tracking data is retrieved from the cache based on the UUID of the winning event URL at operation 702. At operation 704, it is determined if the tracking data includes the advertiser cost for the occurrence of the impression or click event. If the advertiser cost is present in the URL, a cost adjustment to the cost to be charged to the advertiser is calculated at operation 706, such as to more accurately reflect the actual cost of the impression event. In one or more embodiments, the cost adjustment for presenting the ad using the RTB exchange includes the winning price from the winning event URL minus the advertiser cost from the tracking data retrieved from the cache. If the advertiser cost is not present in the retrieved data, the entry in the cache associated with the same UUID as the winning event URL is updated to include a fallback cost at operation 708.

There can be one or more costs associated with an impression event or a click event stored in a URL or the cache data. The costs can include an advertiser cost and a winning cost. The advertiser cost is set by the ad campaign. The winning cost is set in response to an ad winning an auction through the RTB exchange and reflects the cost associated with getting the auction. The winning price from the RTB exchange may not be available when it is time to bill the advertiser for the impression or click events. This is because there is no guarantee of receiving a winning event URL in a specific time frame. The fallback cost can be used in place of the winning price. If the winning price is received after the fallback cost has been written to the cache, then the fallback cost can be overwritten with the winning price, such as to help calculate a more accurate cost.

Persistent storage is updated at operation 710 regardless of whether the actual cost or a fallback cost is used to charge the advertiser. If a cache entry includes a fallback cost and the winning price is subsequently received, the cache entry can be updated to include the winning price, a cost adjustment can be determined for the impression or click event, and/or persistent storage can be updated to reflect the winning price and/or the cost adjustment, such as to more accurately bill the advertiser for the click or impression event.

An example of a cache entry is provided. Note that this is merely an example of cache entry fields, and the cache entry can include more or less data for each URL stored in the cache.

### CACHE ENTRY:

{UUID, //Uniquely identify the advertising event opportunity
EVENT TYPE, //Click, impression, or winning event URL
PUBLICATION ID/CREATIVE ID, //Indicates the ad or content associated with the event type

### SUPPORTING PRICE, MARK UP PRICE, PERCENT MARKUP,

ORIGINAL BID, //Set by ad campaign data details
BID PRICE, //Sent to RTB exchange (maybe adjusted from original bid)
[ADVERTISER COST], //Populated by chargeable impression or click event
[WINNING PRICE], //To be populated by winning event URL data

### [FALLBACK COST]}

The methods and systems as disclosed can be used alone or in combination. For example, the methods 400, 600, and 700 or 500, 600, and 700 can be used in combination, such as to realize a variety of different advantages. The systems 100, 200, and 300 can be used to implement any of the methods or combinations of methods discussed herein.

The data from the cache 108 can be sent to persistent storage where the data is retrieved for billing and/or analytics purposes. The URLs that have been stored in the cache that are associated with a billing event are used for billing purposes and the URLs stored in the cache and not associated with a billing event are used only for analytics purposes. Some URLs are stored directly to persistent storage without first storing the URL or any part of the URL in the cache first. The bill created or the analytics performed are presented to a user, such as in the form of a document to be viewed on a computer monitor or other display device or in a paper or other tangible form.

FIG. 8 illustrates, by way of example, a block diagram of an embodiment of a computer network environment 800 in which the systems and methods discussed herein can be deployed and/or performed. The system 100, 200, or 300 can be deployed or the process 400, 500, 600, or 700 can be implemented using the environment 800. In one or more embodiments, the ads serving module 104 and the ads tracking module 106 can be implemented as application server modules 806, such as by incorporating the module 104 and/or 106 in the application server module(s) 806. In one or more embodiments, the URL cache 108 and/or the fallback cost cache 214 can be a part of the data layer.

The computer network environment 800 can include a social networking system 802 that includes one or more application server modules 806 that provide any number of applications and services that leverage the social graph data database 828 maintained by the social networking system 802. For example, the social networking system 802 may provide a photo sharing application, a job posting and browsing service, a question-and-answer service, and so forth, which may include presentation of advertisements or other content, such as an article, using the service.

The social network environment 800 can provide a social networking service. A social networking service is an online service, platform and/or site that allows users of the service to build or reflect social networks or social relations among members. Typically, users construct profiles, which may include characteristics (e.g., personal information), such as the member's name, contact information, employment information, photographs, personal messages, status information, links to web-related content, blogs, and so on. In order to build or reflect these social networks or social relations among members, the social networking environment 800 allows members to identify, and establish links or connections with other members. For instance, in the context of a business networking service (a type of social networking service), a person may establish a link or connection with his or her business contacts, including work colleagues, clients, customers, personal contacts, and so on. With a social networking service, a person may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of business networking purposes and a social networking service may likewise be used for business networking purposes as well as or in place of social networking purposes.

As shown in FIG. 8, the front end includes the UI module 102 and the client(s) 818 and 820. The clients 818 and 820 render web pages presented using the UI module 102.

The application logic layer can include various application server modules 806, which, in conjunction with the UI module 102, generate various UIs (e.g., web pages) with data retrieved from one or more sources of various data sources in the data layer. In some embodiments, individual application server modules 806 can be used to implement the functionality associated with various applications, services and/or features of the social networking environment 800. For instance, a social networking service may provide a broad variety of applications and services, to include the ability to search for and browse profile pages, job listings, or news articles. Additionally, applications and services may allow users to share content with one another, for example, via email, messages, and/or content postings (sometimes referred to as status updates, such as on a profile page) via a data feed (e.g., specifically tailored) to a user. The application server modules 806 can provide the functionality that crowdsources information from users of the social networking service 802.

As shown in FIG. 8, the data layer includes several databases, such as the database 804 for storing profile data, including both user profile data as well as profile data for various entities (e.g., companies, schools, non-profit organizations, government organizations, and other organizations) represented in the social graph maintained by the social networking service, such as in the social graph data database 828. Consistent with some embodiments, when a person initially registers to become a user of the social networking service, the person can be prompted to provide some personal information, such as his or her name, age (e.g., birthdate), gender, interests, contact information, home town, address, the names of the user's spouse and/or family users, educational background (e.g., schools, majors, matriculation and/or graduation dates, etc.), employment history, skills, professional organizations, and so on. This information, generally referred to as user profile information or user characteristic(s), is stored, for example, in the database 826.

Similarly, when a representative of an organization initially registers the organization with the social networking service (e.g., represented by the social networking system 802), the representative may be prompted to provide certain information about the organization. This information—generally referred to as entity profile information—may be stored, for example, in the database 826 or another database (not shown). With some embodiments, the profile data may be processed (e.g., in the background or offline, by the offline data processing module 832) to generate various derived profile data. For example, if a user has provided information about various job titles the user has held with the same or different companies, or for how long, this information can be used to infer or derive a user profile attribute indicating the user's overall seniority level, or seniority level within a particular entity. With some embodiments, importing or otherwise accessing data from one or more externally hosted data sources may enhance profile data for both users and organizations. For instance, with companies in particular, financial data may be imported from one or more external data sources, and made part of an entity's profile. Another example can include importing information regarding an entity that has an auto-created profile page.

The module 832 can be used to perform analytics on the data stored in the persistent storage (e.g., 826, 828, and/or 830). Analytics includes mining data to determine, for example, common characteristics between users that have selected an ad or other content (such as by clicking on the content). The analytics can be used to help increase a user's online presence, the number of user's a post reaches, and/or determine a better marketing strategy for a business. Analytics can help a user determine social values of users that interact with their content, what cultures are more likely to be impacted by the content, and how social media efforts affect search engine optimization algorithms, among others. Analytics can also indicate which phrasing or verbiage should be used in a sentence to have more impact in a social media post.

The module 832 can also be used for billing advertisers for advertising campaigns. The module 832 accesses the data in the persistent storage to determine if the campaign is satisfied or how many impressions or clicks were received for the campaign. The module 832 then determines how much to charge the advertiser for each impression and/or click event and produces a bill that can be displayed to the advertiser, such as by using the client 818 or 820 or other device that includes a display. The data used by the module 832 can include data from fields in the URLs from the cache 108, such as URLs that include data that was appended to the URL while stored in the cache 108, and then stored in persistent storage. Additionally or alternatively, the bill can be forwarded to the advertiser as a hard copy.

Once registered, a user may invite other users, or be invited by other users, to connect via the environment 800. A “connection” may require a bi-lateral agreement by the users, such that both users acknowledge the establishment of the connection. Similarly, with some embodiments, a user may elect to “follow” another user. In contrast to establishing a connection, the concept of “following” another user typically can be a unilateral operation, and at least with some embodiments, does not require acknowledgement or approval by the user that is being followed. When one user follows another user, the user who is following may receive content postings, status updates, or other content postings published by the user being followed, or relating to various activities undertaken by the user being followed. Similarly, when a user follows an organization, the user becomes eligible to receive content postings published on behalf of the organization and/or system or service-generated content postings that relate to the organization. For instance, messages or content postings published on behalf of an organization that a user is following will appear in the user's personalized feed. In any case, the various associations and relationships that the users establish with other users, or with other entities and objects, can be stored and maintained within the social graph data database 828.

As users interact with the various applications, services, or content made available via the environment 800, the users' behavior (e.g., content viewed, links selected, etc.) may be monitored and information concerning the users' behavior may be stored, for example, in the user activity and behavior data database 830. The database 830 can include the cache 108 or 214. The database 830 can act as a persistent storage for the advertisement tracking data, such as can include the data from the click event URL, impression event URL, and/or the winning event URL.

The information may be used to infer a user's intent and/or interests, and to classify the user as being in various categories. For example, if the user performs frequent searches of job listings, thereby exhibiting behavior indicating that the user is a likely job seeker, this information can be used to classify the user as a job seeker. This classification can then be used as an attribute or characteristic. The attribute or characteristic can be used by others to target the user for receiving advertisements, messages, content postings, or a recommendation. Accordingly, an entity that has available job openings can publish a content posting that is specifically directed to certain users (e.g., users) of the social networking service who are likely job seekers, and thus, more likely to be receptive to recruiting efforts.

This information may be used to determine if an advertising campaign has completed, how much an advertiser is to be charged for a click/impression event occurrence, and/or which ads or other content will be used to populate a user's display on the client 818 or 820. This information may be used to track advertisement impressions and click events for general analytics, such as can be used for improved targeting of ads and tailoring of advertisement presentation and content. The offline data processing module 832 can perform such analytics operations.

Certain embodiments are described herein as including logic or a number of components, modules, or mechanisms. Modules described herein include the UI module 102, the ads serving module 104, the ads tracking module 106, the offsite publishers module 212, the application server module(s) 306, and the offline data processing module 332. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

In one embodiment, the modules are written in a computer-programming and/or scripting language. Examples of such languages include, but are not limited to, C, C++, C#, Java, JavaScript, Perl, Python, or any other computer programming and/or scripting language now known or later developed.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, a least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

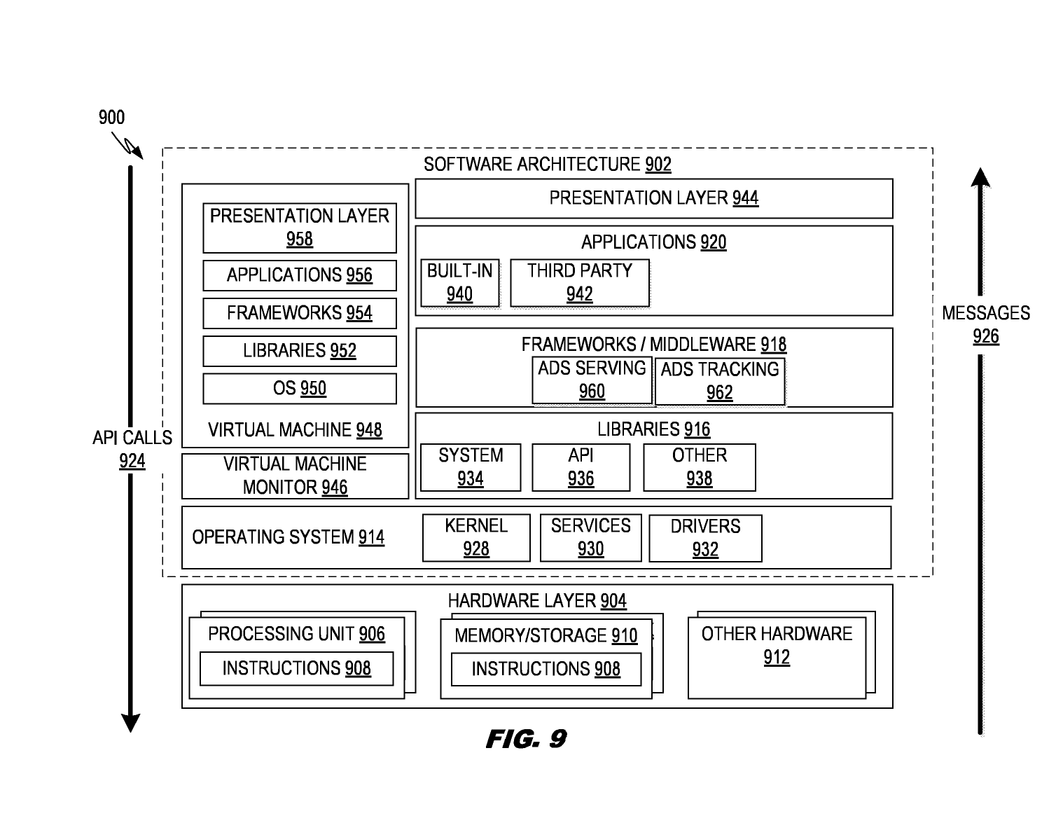

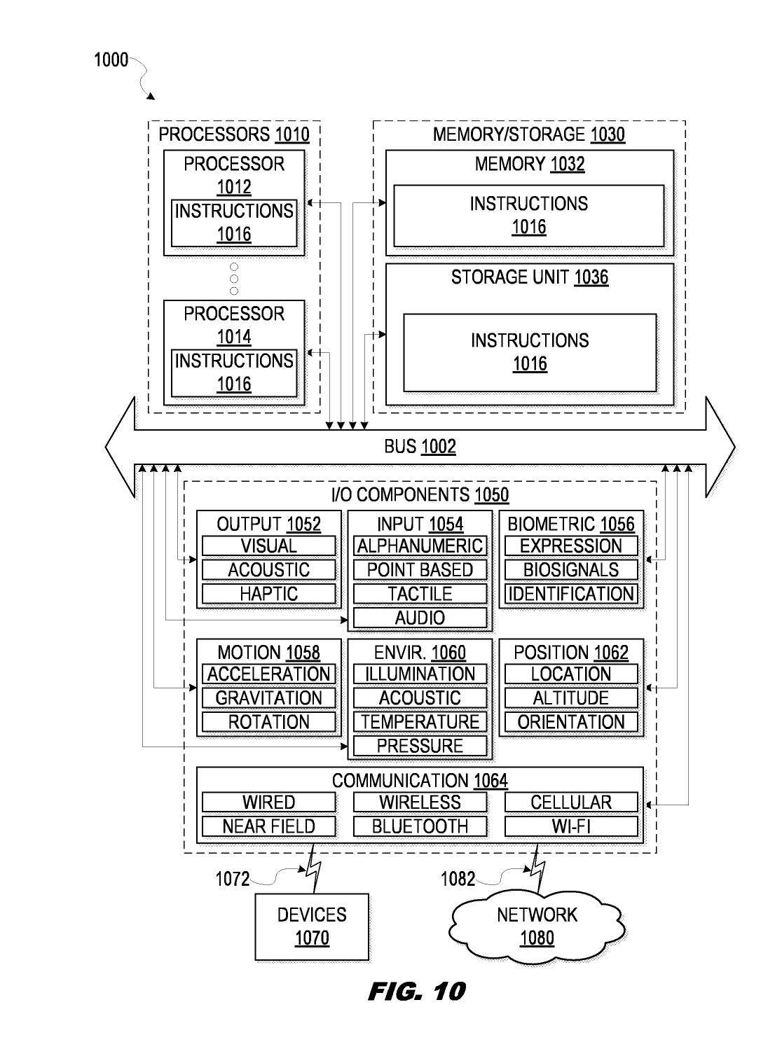

FIG. 9 is a block diagram 900 illustrating a representative software architecture 902, which may be used in conjunction with various hardware architectures herein described. FIG. 9 is merely a non-limiting example of a software architecture and it will be appreciated that many other architectures may be implemented to facilitate the functionality described herein. The software architecture 902 may be executing on hardware such as machine 1000 of FIG. 10 that includes, among other things, processors 1010, memory 1030, and I/O components 1050. A representative hardware layer 904 is illustrated and can represent, for example, the machine 1000 of FIG. 10. The representative hardware layer 904 comprises one or more processing units 906 having associated executable instructions 908. Executable instructions 908 represent the executable instructions of the software architecture 902, including implementation of the methods, modules and so forth of FIGS. 1-10. Hardware layer 904 also includes memory and/or storage modules 910, which also have executable instructions 908. Hardware layer 904 may also comprise other hardware as indicated by 912 which represents any other hardware of the hardware layer 904, such as the other hardware illustrated as part of machine 1000.

In the example architecture of FIG. 9, the software 902 may be conceptualized as a stack of layers where each layer provides particular functionality. For example, the software 902 may include layers such as an operating system 914, libraries 916, frameworks/middleware 918, applications 920 and presentation layer 922. Operationally, the applications 920 and/or other components within the layers may invoke application programming interface (API) calls 924 through the software stack and receive a response, returned values, and so forth illustrated as messages 926 in response to the API calls 924. The layers illustrated are representative in nature and not all software architectures have all layers. For example, some mobile or special purpose operating systems may not provide a frameworks/middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system 934 libraries (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks 918 (also sometimes referred to as middleware) may provide a higher-level common infrastructure that may be utilized by the applications 920 and/or other software components/modules. For example, the frameworks 918 may provide various graphic user interface (GUI) functions, high-level resource management, high-level location services, and so forth. The frameworks 918 may provide a broad spectrum of other APIs that may be utilized by the applications 920 and/or other software components/modules, some of which may be specific to a particular operating system or platform. The frameworks 918 can include the ads serving 960 and the ads tracking 962 frameworks. The ads serving 960 and the ads tracking 962 frameworks are specific software implementations of the ads serving module 104 and the ads tracking module 106, respectively. The ads serving module 104 and the ads tracking module 106 can likewise be implemented as applications 920, applications 956, or frameworks 954.

The applications 920 includes built-in applications 940 and/or third party applications 942. Examples of representative built-in applications 940 may include, but are not limited to, a contacts application, a browser application, a book reader application, a location application, a media application, a messaging application, and/or a game application. Third party applications 942 may include any of the built in applications as well as a broad assortment of other applications. In a specific example, the third party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 942 may invoke the API calls 924 provided by the mobile operating system such as operating system 914 to facilitate functionality described herein.

The applications 920 may utilize built in operating system functions (e.g., kernel 928, services 930 and/or drivers 932), libraries (e.g., system 934, APIs 936, and other libraries 938), frameworks/middleware 918 to create user interfaces to interact with users of the system. Alternatively, or additionally, in some systems interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware machine (such as the machine of FIG. 10, for example). A virtual machine is hosted by a host operating system (operating system 914 in FIG. 10) and typically, although not always, has a virtual machine monitor 946, which manages the operation of the virtual machine as well as the interface with the host operating system (i.e., operating system 914). A software architecture executes within the virtual machine such as an operating system 950, libraries 952, frameworks/middleware 954, applications 956 and/or presentation layer 958. These layers of software architecture executing within the virtual machine 948 can be the same as corresponding layers previously described or may be different.

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an apple, an app, or other executable code) for causing the machine 1000 to perform any one or more of the methodologies discussed herein may be executed. For example the instructions may cause the machine to execute the flow diagrams of FIGS. 4, 5, 6, and 7. Additionally, or alternatively, the instructions may implement UI module 102, the ads serving module 104, the ads tracking module 106, the offsite publishers module 212, the application server module(s) 306, and the offline data processing module 332 of FIGS. 1-3, and so forth. The instructions transform the general, non-programmed machine into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1012 and processor 1014 that may execute instructions 1016. The term “processor” is intended to include multi-core processor that may comprise two or more independent processors (sometimes referred to as “cores”) that may execute instructions contemporaneously. Although FIG. 10 shows multiple processors, the machine 1000 may include a single processor with a single core, a single processor with multiple cores (e.g., a multi-core process), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of processors 1010 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as, location via Internet Protocol (IP) geo-location, location via Wi-Fi® signal triangulation, location via detecting a NFC beacon signal that may indicate a particular location, and so forth.

### EXAMPLES AND NOTES

The present subject matter can be described by way of several examples.

Example 1 can include or use subject matter (such as a system, a method, a means for performing acts, or a machine readable medium including instructions that, when performed by the machine, can cause the device to perform operations for tracking click and impression event data using one or more Uniform Resource Locator (URL) caches, one or more advertising event URLs, and one or more winning event URLs), such as can include or use determining whether an entry in any of the one or more URL caches includes a same universally unique identifier (UUID) as a received winning event URL of the one or more winning event URLs or a received advertising event URL of the one or more advertising event URLs, the one or more winning event URLs including fields populated with data associated with winning an opportunity to present an advertisement through a real time bidding exchange including a winning bid price field that indicates how much money was bid for the opportunity, and the one or more advertising event URLs including fields populated with data associated with an advertisement being served to a user, viewed by the user, or selected by the user, in response to determining an entry in the one or more URL caches includes the same UUID, merging data from the received winning event URL or the received advertising event URL into the entry that is not present in the entry in the one or more URL caches, in response to determining no entry in the one or more URL caches includes the same UUID, creating a new entry in a cache of the one or more URL caches that includes the UUID and a time to live (TTL), the TTL indicating a time at which the entry is to be removed from the URL cache, in response to the TTL elapsing, updating a persistent storage with the data from the entry, and providing a bill for serving advertisements or analytics information, the bill or analytics information determined using data from the entry in the persistent storage.

Example 2 can include or use, or can optionally be combined with the subject matter of Example 1, to include or use, wherein the received URL is an advertising event URL and the operations further comprise retrieving data from an entry in the URL cache associated with a same UUID as the advertising event URL, determining whether the advertising event URL is associated with a chargeable click or impression event based on the retrieved data or data in the advertising event URL, and in response to determining the advertising event URL is not associated with a chargeable click or impression event, updating a persistent storage with data from the advertising event URL.

Example 3 can include or use, or can optionally be combined with the subject matter of Example 2 to include or use, the operations further comprise in response to determining the advertising event URL is associated with a chargeable click event or impression event, determining if the retrieved data or the advertising event URL includes a field populated with a winning price bid for presenting the advertisement through the real time bidding exchange, in response to determining the retrieved data or the advertising event URL includes the winning price bid, then updating the persistent storage to reflect the retrieved data and data from the advertising event URL.

Example 4 can include or use, or can optionally be combined with the subject matter of Example 3 to include or use, wherein the operations further comprise in response to determining the retrieved data or the advertising event URL does not include the winning price bid, then retrieving a fallback cost from a fallback cost cache, updating the entry in the one or more URL caches associated with the same UUID as the advertising event URL to include the retrieved fallback cost, the fallback cost indicating an amount to be charged for the impression event or the click event if the winning price bid is not determined or received within the time frame specified by the TTL, and updating the persistent storage to reflect the data from the entry in the URL cache.

Example 5 can include or use, or can optionally be combined with the subject matter of Example 1 to include or use, wherein the received URL is a winning event URL and the operations further comprise retrieving data from an entry in the URL cache associated with a same UUID as the winning event URL, determining whether the winning event URL or the retrieved data includes a cost to be charged for creating a click event or impression event associated with the winning event URL, in response to determining the winning event URL or the retrieved data does not include the advertiser cost, retrieving a fallback cost from a fallback cost cache and updating the entry in the URL cache associated with the same UUID as the winning event URL with the retrieved fallback cost, and updating the persistent storage to reflect the data from the entry in the URL cache.

Example 6 can include or use, or can optionally be combined with the subject matter of Example 5 to include or use, wherein the operations further comprise in response to determining the winning event URL or the retrieved data includes the advertiser cost, determining a cost adjustment based on a winning price bid from the winning event URL and the advertiser cost, and updating the persistent storage to reflect the data from the retrieved data and the winning event URL including the determined advertiser cost.

Example 7 can include or use, or can optionally be combined with the subject matter of Example 6 to include or use, wherein the operations further comprise removing the entry from the cache in response to determining the advertiser cost to charge the advertiser and prior to the time indicated by the TTL.

Example 8 can include or use, or can optionally be combined with the subject matter of at least one of Examples 1-7 to include or use, wherein the operations for merging data from the received winning event URL or the received advertising event URL that is not present in the entry includes appending a winning bid price field and associated data from the received winning event URL to a URL in the entry.

Example 9 can include or use, or can optionally be combined with the subject matter of at least one of Examples 1-4 and 8 to include or use wherein the received URL is an advertising event URL and wherein the operations further comprise determining if the advertising event URL is associated with an impression event or a click event, determining if an ad campaign associated with the advertising event URL is a cost per click ad campaign or a cost per impression ad campaign, and in response to determining the advertising URL is associated with an impression event and the ad campaign is a cost per impression ad campaign, updating the URL cache to include data in the advertising URL that is not currently in the URL cache.

Example 10 can include or use, or can optionally be combined with the subject matter of Example 9 to include or use, wherein the operations further comprise in response to determining the advertising URL is associated with an impression event and the ad campaign is a cost per click ad campaign, updating the persistent to include data in the advertising URL without updating the URL cache to include data from the advertising URL.

The above Description of Embodiments includes references to the accompanying figures, which form a part of the detailed description. The figures show, by way of illustration, specific embodiments in which methods, apparatuses, and systems discussed herein can be practiced. These embodiments are also referred to herein as “examples” or “embodiments”. Such embodiments (e.g., examples) can include elements in addition to those shown or described. However, the present inventors also contemplate embodiments in which only those elements shown or described are provided. Moreover, the present inventors also contemplate embodiments using any combination or permutation of those elements shown or described (or one or more aspects thereof), either with respect to a particular embodiment (or one or more aspects thereof), or with respect to other embodiments (or one or more aspects thereof) shown or described herein.

The flowchart and block diagrams in the FIGS. illustrate the architecture, functionality, and operation of possible implementations of systems, methods and computer program products according to various aspects of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The functions or techniques described herein can be implemented in software or a combination of software and human implemented procedures. The software can consist of computer executable instructions stored on computer readable media such as memory or other type of storage devices. The term “computer readable media” is also used to represent any means by which the computer readable instructions can be received by the computer, such as by different forms of wired or wireless transmissions. Further, such functions correspond to modules, which are software, hardware, firmware or any combination thereof. Multiple functions can be performed in one or more modules as desired, and the embodiments described are merely examples. The software can be executed on a digital signal processor, ASIC, microprocessor, or other type of processor operating on a computer system, such as a personal computer, server or other computer system.

The above description is intended to be illustrative, and not restrictive. For example, the above-described embodiments (or one or more aspects thereof) can be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Description of Embodiments, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A non-transitory, machine-readable medium comprising instructions stored thereon, which when executed by a machine cause the machine to perform operations for tracking click and impression event data using one or more Uniform Resource Locator (URL) caches, one or more advertising event URLs, and one or more winning event URLs, the operations comprising:
determining whether an entry in any of the one or more URL caches includes a same universally unique identifier (UUID) as a received winning event URL of the one or more winning event URLs or a received advertising event URL of the one or more advertising event URLs, the one or more winning event URLs including fields populated with data associated with winning an opportunity to present an advertisement through a real time bidding exchange including a winning bid price field that indicates how much money was bid for the opportunity, and the one or more advertising event URLs including fields populated with data associated with an advertisement being served to a user, viewed by the user, or selected by the user;
in response to determining an entry in the one or more URL caches includes the same UUID, joining data from the received winning event URL or the received advertising event URL with data in the entry that is not present in the entry and updating a persistent storage with the joined data;
in response to determining no entry in the one or more URL caches includes the same UUID, creating a new entry in a cache of the one or more URL caches that includes the UUID and a time to live (TTL), the TTL indicating a time at which the entry is to be removed from the URL cache and in response to the TTL elapsing, updating a persistent storage with the data from the entry; and
providing a bill for serving advertisements or analytics information, the bill or analytics information determined using data from the entry in the persistent storage.

2. The non-transitory, machine-readable medium of claim 1, wherein the received URL is an advertising event URL and the operations further comprise:
retrieving data from an entry in the URL cache associated with a same UUID as the advertising event URL;
determining whether the advertising event URL is associated with a chargeable click or impression event based on the retrieved data or data in the advertising event URL; and
in response to determining the advertising event URL is not associated with a chargeable click or impression event, updating a persistent storage with data from the advertising event URL.

3. The non-transitory, machine-readable medium of claim 2, wherein the operations further comprise:
in response to determining the advertising event URL is associated with a chargeable click event or impression event, determining if the retrieved data or the advertising event URL includes a field populated with a winning price bid for presenting the advertisement through the real time bidding exchange;
in response to determining the retrieved data or the advertising event URL includes the winning price bid, then updating the persistent storage to reflect the retrieved data and data from the advertising event URL.

4. The non-transitory, machine-readable medium of claim 3, wherein the operations further comprise:
in response to determining the retrieved data or the advertising event URL does not include the winning price bid, then retrieving a fallback cost from a fallback cost cache, updating the entry in the one or more URL caches associated with the same UUID as the advertising event URL to include the retrieved fallback cost, the fallback cost indicating an amount to be charged for the impression event or the click event if the winning price bid is not determined or received within the time frame specified by the TTL; and
updating the persistent storage to reflect the data from the entry in the URL cache.

5. The non-transitory, machine-readable medium of claim 1, wherein the received URL is a winning event URL and the operations further comprise:
retrieving data from an entry in the URL cache associated with a same UUID as the winning event URL;
determining whether the winning event URL or the retrieved data includes a cost to be charged for creating a click event or impression event associated with the winning event URL;
in response to determining the winning event URL or the retrieved data does not include the advertiser cost, retrieving a fallback cost from a fallback cost cache and updating the entry in the URL cache associated with the same UUID as the winning event URL with the retrieved fallback cost; and
updating the persistent storage to reflect the data from the entry in the URL cache.

6. The non-transitory, machine-readable medium of claim 5, wherein the operations further comprise:
in response to determining the winning event URL or the retrieved data includes the advertiser cost, determining a cost adjustment based on a winning price bid from the winning event URL and the advertiser cost; and
updating the persistent storage to reflect the data from the retrieved data and the winning event URL including the determined advertiser cost.

7. The non-transitory, machine-readable medium of claim 6, wherein the operations further comprise:
removing the entry from the cache in response to determining the advertiser cost to charge the advertiser and prior to the time indicated by the TTL.

8. The non-transitory, machine-readable medium of claim 1, wherein the instructions for merging data from the received winning event URL or the received advertising event URL that is not present in the entry includes appending a winning bid price field and associated data from the received winning event URL to a URL in the entry.

9. The non-transitory, machine-readable medium of claim 1, wherein the received URL is an advertising event URL and wherein the operations further comprise:
determining if the advertising event URL is associated with an impression event or a click event;
determining if an ad campaign associated with the advertising event URL is a cost per click ad campaign or a cost per impression ad campaign; and
in response to determining the advertising URL is associated with an impression event and the ad campaign is a cost per impression ad campaign, updating the URL cache to include data in the advertising URL that is not currently in the URL cache.

10. The non-transitory, machine-readable medium of claim 9, wherein the operations further comprise:
in response to determining the advertising URL is associated with an impression event and the ad campaign is a cost per click ad campaign, updating the persistent to include data in the advertising URL without updating the URL cache to include data from the advertising URL.

11. A method for tracking click and impression event data using one or more Uniform Resource Locator (URL) caches, one or more advertising event URLs, and one or more winning event URLs, the method comprising operations performed using one or more hardware processors, the operations comprising:
determining whether an entry in any of the one or more URL caches includes a same universally unique identifier (UUID) as a received winning event URL of the one or more winning event URLs or a received advertising event URL of the one or more advertising event URLs, the one or more winning event URLs including fields populated with data associated with winning an opportunity to present an advertisement through a real time bidding exchange including a winning bid price field that indicates how much money was bid for the opportunity, and the one or more advertising event URLs including fields populated with data associated with an advertisement being served to a user, viewed by the user, or selected by the user;
in response to determining an entry in the one or more URL caches includes the same UUID, merging data from the received winning event URL or the received advertising event URL into the entry that is not present in the entry in the one or more URL caches;
in response to determining no entry in the one or more URL caches includes the same UUID, creating a new entry in a cache of the one or more URL caches that includes the UUID and a time to live (TTL), the TTL indicating a time at which the entry is to be removed from the URL cache;
in response to the TTL elapsing, updating a persistent storage with the data from the entry; and
displaying a bill for serving advertisements or analytics information, the bill or analytics information determined using data from the entry in the persistent storage.

12. The method of claim 11, wherein the received URL is an advertising event URL and the operations further comprise:
retrieving data from an entry in the URL cache associated with a same UUID as the advertising event URL;
determining whether the advertising event URL is associated with a chargeable click or impression event based on the retrieved data or data in the advertising event URL; and
in response to determining the advertising event URL is not associated with a chargeable click or impression event, updating a persistent storage with data from the advertising event URL.

13. The method of claim 12, wherein the operations further comprise:
in response to determining the advertising event URL is associated with a chargeable click event or impression event, determining if the retrieved data or the advertising event URL includes a field populated with a winning price bid for presenting the advertisement through the real time bidding exchange;
in response to determining the retrieved data or the advertising event URL includes the winning price bid, then updating the persistent storage to reflect the retrieved data and data from the advertising event URL.

14. The method of claim 13, wherein the operations further comprise:
in response to determining the retrieved data or the advertising event URL does not include the winning price bid, then retrieving a fallback cost from a fallback cost cache, updating the entry in the one or more URL caches associated with the same UUID as the advertising event URL to include the retrieved fallback cost, the fallback cost indicating an amount to be charged for the impression event or the click event if the winning price bid is not determined or received within the time frame specified by the TTL; and
updating the persistent storage to reflect the data from the entry in the URL cache.

15. The method of claim 11, wherein merging data from the received winning event URL or the received advertising event URL that is not present in the entry includes appending a winning bid price field and associated data from the received winning event URL to a URL in the entry.

16. A system comprising:
one or more hardware processors;
one or more URL caches, a persistent storage, and one or more memories communicatively coupled to the one or more hardware processors, the one or more memories including instructions stored thereon, which when executed by the one or more processors, cause the one or more processors to perform operations for tracking click and impression event data using one or more Uniform Resource Locator (URL) caches, one or more advertising event URLs, and one or more winning event URLs, the operations comprising:
determining whether an entry in any of the one or more URL caches includes a same universally unique identifier (UUID) as a received winning event URL of the one or more winning event URLs or a received advertising event URL of the one or more advertising event URLs, the one or more winning event URLs including fields populated with data associated with winning an opportunity to present an advertisement through a real time bidding exchange including a winning bid price field that indicates how much money was bid for the opportunity, and the one or more advertising event URLs including fields populated with data associated with an advertisement being served to a user, viewed by the user, or selected by the user;
in response to determining an entry in the one or more URL caches includes the same UUID, merging data from the received winning event URL or the received advertising event URL into the entry that is not present in the entry in the one or more URL caches;
in response to determining no entry in the one or more URL caches includes the same UUID, creating a new entry in a cache of the one or more URL caches that includes the UUID and a time to live (TTL), the TTL indicating a time at which the entry is to be removed from the URL cache;
in response to the TTL elapsing, updating a persistent storage with the data from the entry; and
displaying a bill for serving advertisements or analytics information, the bill or analytics information determined using data from the entry in the persistent storage.

17. The system of claim 16, wherein the received URL is a winning event URL and the operations further comprise:
retrieving data from an entry in the URL cache associated with a same UUID as the winning event URL;
determining whether the winning event URL or the retrieved data includes a cost to be charged for creating a click event or impression event associated with the winning event URL;
in response to determining the winning event URL or the retrieved data does not include the advertiser cost, retrieving a fallback cost from a fallback cost cache and updating the entry in the URL cache associated with the same UUID as the winning event URL with the retrieved fallback cost; and
updating the persistent storage to reflect the data from the entry in the URL cache.

18. The system of claim 17, wherein the operations further comprise:
in response to determining the winning event URL or the retrieved data includes the advertiser cost, determining a cost adjustment based on a winning price bid from the winning event URL and the advertiser cost; and
updating the persistent storage to reflect the data from the retrieved data and the winning event URL including the determined advertiser cost.

19. The system of claim 16, wherein the received URL is an advertising event URL and wherein the operations further comprise:
determining if the advertising event URL is associated with an impression event or a click event;
determining if an ad campaign associated with the advertising event URL is a cost per click ad campaign or a cost per impression ad campaign; and
in response to determining the advertising URL is associated with an impression event and the ad campaign is a cost per impression ad campaign, updating the URL cache to include data in the advertising URL that is not currently in the URL cache.

20. The system of claim 19, wherein the operations further comprise:
in response to determining the advertising URL is associated with an impression event and the ad campaign is a cost per click ad campaign, updating the persistent to include data in the advertising URL without updating the URL cache to include data from the advertising URL.
